(19) United States
(12) Patent Application Publication
(10) Pub. No.: US 2011/0246370 A1
(43) Pub. Date: Oct. 6, 2011

(54) FACILITATING TRANSACTIONS USING UNSUPPORTED TRANSACTION IDENTIFIER TYPES

(75) Inventors: Tiejun Wang, Arlington, VA (US); Tiehong Wang, Arlington, VA (US); Xiaoyu Li, Beijing (CN)

(73) Assignee: Sellerbid, Inc., Arlington, VA (US)

(21) Appl. No.: 13/075,782

(22) Filed: Mar. 30, 2011

Related U.S. Application Data
(60) Provisional application No. 61/282,792, filed on Mar. 31, 2010.

(51) Int. Cl. G06Q 30/00; G06F 17/00; H04L 9/28; G06F 17/30

(52) U.S. Cl. 705/64; 235/375; 705/26.1; 707/769; 707/E17.014

(57) ABSTRACT

Facilitating transactions using unsupported transaction identifier types entails receiving a unique transaction indicator having a transaction indicator type, and an indication that a corresponding transaction is to be carried out with a device that does not adequately support the transaction indicator type, and sending information to the device to allow the corresponding transaction to be completed. In one example, an encoded version of the unique transaction indicator is prepared by dividing an image constituting the unique transaction indicator into a plurality of sub-areas, and representing each of the sub-areas using the characters, which respectively represent the content of each sub-area.

### CROSS REFERENCE TO RELATED APPLICATIONS

This application claims priority to U.S. Provisional Application Ser. No. 61/282,792, filed on Mar. 31, 2010, the entire contents of which are hereby incorporated by reference.

### BACKGROUND OF THE INVENTION

1. Field of the Invention

The present invention relates generally to facilitating transactions using unsupported transaction identifier types.

2. Description of the Related Art

Two dimensional codes have been implemented recently by mobile phones and other devices, for use in connection with a variety of applications and services.

For example, an online transaction that is to be completed with an offline pickup may implement a two dimensional code for purchase identification and verification. That is, a user with a mobile device equipped with the two dimensional coding capability brings the mobile device to the retail site, and prompts display of a unique two dimensional code that is used to identify the item to be picked up and to verify the corresponding transaction.

However, not all mobile devices are equipped with two dimensional code capability.

Techniques are needed for allowing mobile devices that are not equipped with some or all two dimensional code capabilities to participate in transactions ordinarily requiring them.

### SUMMARY OF THE INVENTION

Facilitating transactions using unsupported transaction identifier types entails receiving a unique transaction indicator having a transaction indicator type, and an indication that a corresponding transaction is to be carried out with a device that does not adequately support the transaction indicator type, and sending information to the device to allow the corresponding transaction to be completed. In one example, an encoded version of the unique transaction indicator is prepared by dividing an image constituting the unique transaction indicator into a plurality of sub-areas, and representing each of the sub-areas using the characters, which respectively represent the content of each sub-area.

The present invention can be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the present invention are more fully disclosed in the following specification, reference being had to the accompanying drawings, in which:

FIG. 1 is a schematic diagram illustrating an example of a system for facilitating transactions using unsupported transaction identifier types.

FIG. 2 is a schematic diagram illustrating another example of a system for facilitating transactions using unsupported transaction identifier types.

FIG. 3 is a block diagram illustrating an example of a code conversion server apparatus configured to facilitate transactions by devices that do not support transaction identifier type(s).

FIG. 4 is a block diagram illustrating an example of a mobile terminal device configured to operate in conjunction with the code conversion server.

FIG. 5 is a block diagram illustrating an example of a code generator apparatus configured to facilitate transactions by devices that do not support transaction identifier types.

FIG. 6 is an event diagram illustrating an example of a method for facilitating transactions using unsupported transaction identifier types.

FIG. 7 is an event diagram illustrating another example of a method for facilitating transactions using unsupported transaction identifier types.

FIG. 8 is an event diagram illustrating an example of completing a transaction using a two dimensional code upon proximity detection of a corresponding mobile device.

FIG. 9 is an event diagram illustrating an example of completing a transaction using a two dimensional code in conjunction with a group based offer associated with the location of a corresponding mobile device.

FIG. 10 is a flow diagram illustrating an example of encoding image content.

### DETAILED DESCRIPTION OF THE INVENTION

In the following description, for purposes of explanation, numerous details are set forth, such as flowcharts and system configurations, in order to provide an understanding of one or more embodiments of the present invention. However, it is and will be apparent to one skilled in the art that these specific details are not required in order to practice the present invention.

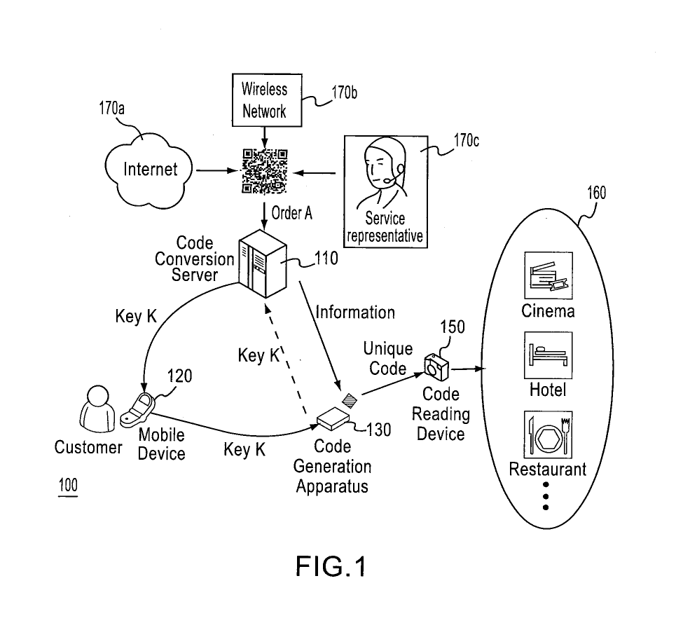

FIG. 1 is a schematic diagram illustrating an example of a system 100 for facilitating transactions using unsupported transaction identifier types. The system 100 includes a code conversion server 110 that communicates with a user device, typically a mobile device 120, and a code generator apparatus 130.

The code conversion server 110 is also configured to communicate with a variety of order information services 170a-c, including Internet 170a, wireless network 170b, and customer representative 170c services. These services provide goods and services that may be ordered by the user. The order may be placed through the consumer's mobile device 120. Alternatively, the order may be separately placed using a home computer, telephone, person-to-person contact or the like, with the mobile device 120 used for completion of the transaction as described herein.

The code generator apparatus 130 is also configured to communicate with the code conversion server 110 and mobile device 120, and engages in corresponding communication of codes to the code reading device 150, which would typically be implemented at a point-of-sale terminal or other apparatus of merchant locations 160 where the transaction could be completed, such as the illustrated examples of cinema, hotel and restaurant.

With this system 100, consumers may shop over an e-commerce platform provided by the Internet 170a, voice platform 170b, or 3G/4G wireless networks 170c to place an order for goods or services. Optionally, the payment transaction may be completed at this time, after which order information “A” is sent to the code conversion server 110, which saves and encrypts the order information. In connection with the order, a key “K” corresponding to order information A is sent in an encrypted message, such as through SMS communications as a message to the consumer's mobile device 120 (e.g., a mobile phone). By way of example, the key K may be a string of numbers. However, the key may also be a cellular phone number, and NFG tag, a PN code, a random number, an encryption key, or any number of alternative forms. After receiving the key K, the consumer brings his mobile device 120 to the merchant location 160. Of course, optionally the key K may be received while the consumer already has his mobile device 120 at the merchant location 160.

The order information may variously be conveyed to the merchant location, and may be sent through various types of communications (telephone, online, 3G, etc.). In one example the order information (“order A”) will be sent to the code generation apparatus 130 from the code conversion server 110 when the key K is sent to the mobile device 120. The Order A is stored at the code generation apparatus 130, and the customer carries the mobile device 120 with the key K to pick up the previously stored order A. As another example, the code conversion server 130 may send the key K to the code generation apparatus 110 when the customer carries the mobile device 120 with the key K to the code generation apparatus 130. The difference between the two ways is that the code generation apparatus 130 does not need to have transmission function, but instead may use its ability to store information. As still another alternative, the order A information may be encrypted by using the encryption key (which may be key K) when the content of order A is transmitted from the code conversion server 110 to the code generation apparatus 130. The encrypted information will be de-encrypted by using key K received by the code generation apparatus 130 from the consumer's mobile device 120. And the information of order A is encrypted before it is transmission. As still another alternative the order information may be separately transmitted to the merchant location, with the technique for identifying and authenticating the consumer's pick up of the order being undertaken as described herein.

With the key K present in the mobile device 120, the consumer may then initiate communication of the key K to the code generation apparatus 130. This may be accommodated in the form of active user-initiation of the transmission of the key K to the code generation apparatus 130, whether without notice or based upon an exchange with the code generation apparatus 130.

Alternatively, the key K is automatically sent to the code generation apparatus based upon proximity of the mobile device 120 to the code generation apparatus 130. Preferably, the code generation apparatus 130 operates as a near field communication (NFC) reader and the mobile device 120 includes a unique NFC identifier (NFC tag) that is automatically provided to the code generation apparatus 130 via NFC when the mobile device 120 is brought within the NFC-prescribed proximity to the code generation apparatus. In this example, the “key” used to associate the consumer's mobile device 120 to the code may be the NFC tag itself. That is, the key K is the NFC tag for that mobile device 120.

Alternatively, once the mobile device 120 is recognized from the NFC tag, a separate communication channel may be used to convey the key and/or other additional information from the mobile device 120 to the code generation apparatus 130. This separate communication channel may be different from an NFC channel, such as a Bluetooth. With this feature, the mobile device 120 is initially recognized when it is brought proximate to the code generation apparatus 130, and then the Bluetooth pairing for more rich communications immediately ensues (because the device has been recognized) without requiring the user to engage in all of the traditional inputs or requirements for such pairing. This allows the more capable Bluetooth channel to be automatically engaged, and then used for delivering the key K and any other necessary information.

Still referring to FIG. 1, once the code generation apparatus 130 has the key, it may then pass the key K to the code conversion server 110, which then returns information useful for completing the transaction.

In one example, the information sent to the code generation apparatus 130 is the code that is associated to the key. The code acts as a unique transaction identifier that identifies the order placed by the consumer through one of the order information services 170a-c as described above. In one embodiment, the code is a two dimensional code, and more specifically a QR code. However, the code may be anything that can be used to uniquely identify the transaction, but which is not necessarily supported by the mobile device 120.

Once the code is provided to the code generation apparatus 130, the code can be reproduced (e.g., printed, displayed on a screen, provided to a code reading device 150, etc.) to facilitate completion of the transaction and thus fulfillment of the order that had been placed.

In another example, the information that is sent to the code generation apparatus 130 is encrypted information about the order. There may be circumstances where the key K does not need to be sent to the code conversion server 110. Thus, the transmission to the server can be considered optional, and it is shown as a dotted line. For example, encrypted information about the order (the code and/or order information) may be decrypted by the code generation apparatus 130 once it has received the key K from the mobile device 120, without having to query the code conversion server 110 with the key K.

In still another example, a partial set of information is sent in encrypted form to the code generation apparatus 130, along with other information that is not encrypted. The key K allows the code generation apparatus 130 to decrypt the encrypted partial set of information, so that it can be joined to the other non-encrypted information, pursuant to completing the order.

It is noted that although two devices for the code generation apparatus 130 and code reading device 150 have been described, these can simply be two elements or functions provided at the merchant location 160, such as a single POS terminal (i.e., the code generation apparatus 130 and the code reading device 150 may be embedded as one device).

The system 100 offers several useful features. First, consumer information can be server-stored, reducing consumer need (and possible merchant need) for storage and storage management. Also, the code conversion server can send the encryption/decryption key corresponding to the consumer's order information to the consumer, enabling the consumer to use his mobile phone that does not support MMS function to shop online. Still further, since the key may optionally be a string of simple numbers that can be sent by ordinary SMS, there is a potential reduction in consumer costs for network data transmission required for multimedia content, and would generally help to reduce the cost of e-commerce business. Still further, storing the actual consumer order information in the code conversion server offers potential protection of consumers' privacy and confidential information.

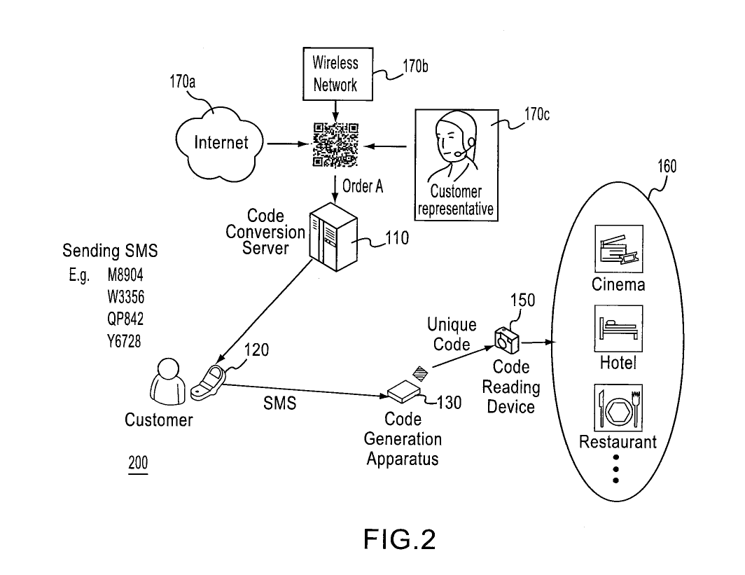

FIG. 2 is a schematic diagram illustrating another example of a system 200 for facilitating transactions using unsupported transaction identifier types. The system 200 similarly includes the code conversion server 110, mobile device 120, code generation apparatus 130 and code reader 150, so their basic features need not be re-described.

However, a difference between FIG. 1 and FIG. 2 is that the need for a direct communication channel between the code conversion server 110 and the code generation apparatus 130 may be omitted. Instead, the system 200 implements an encoding and decoding of the code, with the mobile device 120 being capable of receiving and re-transmitting the encoded version of the code, so that it may receive that version and pass it to the code generation apparatus 130, which then decodes it to reproduce the code.

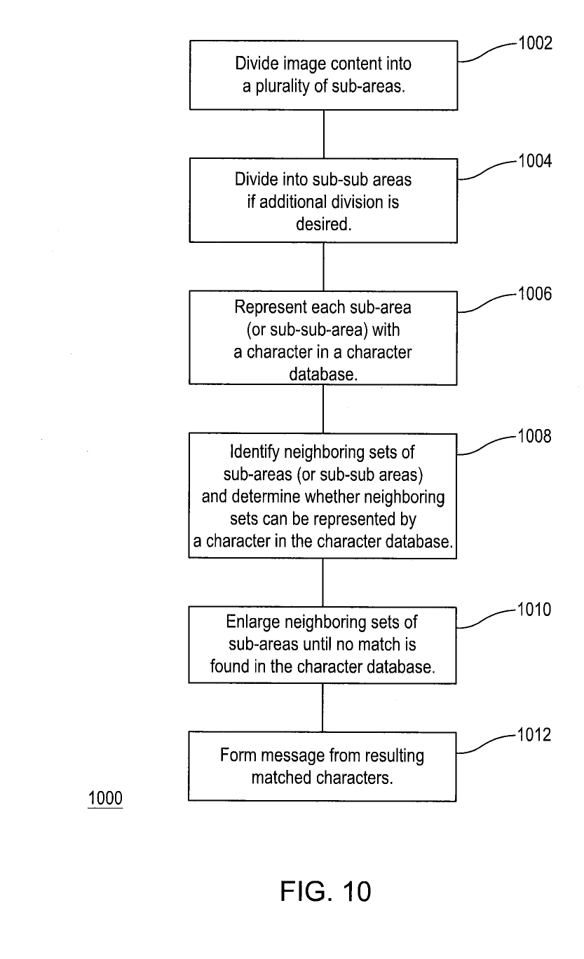

An example of the encoding/decoding technique, and corresponding aspects, is described as follows. For ease of reading, an example involving a QR code is described. However, it should be understood that the encoding/decoding technique may be similarly applied to any code, or indeed any image, in situations where the mobile device 120 does not support the display and/or processing of the code or image, but wishes to rely upon transmission of the encoded version to carry out a transaction or other opportunity. FIG. 10 is a flow diagram illustrating an example of encoding 1000 image content and is concurrently referenced in the following description.

The size of a QR-dimensional code ranges from 21*21 to 177*177. For this example, presume 160*160.

a) Define a desired division of the whole image into sub-images. Specifically, the entire 160*160 area is divided into smaller sub-areas, such as 10*10. Therefore, each sub-area is a 16*16 point-area. A 16*16 point-area can be represented as a character in a mobile device (e.g., typical cellular phone). Of note, 16*16, 20*20, 24*24 are the most commonly used by different cell phones. However, the present invention is not limited to these examples.

b) Representation Character. This feature of the technique entails identification of a character that is supported by the mobile device display (e.g., cell phone screen). In other words, a character which mobile device display can understand to represent the corresponding portion of the QR code image.

c) Define a Pilot Format. Optionally, so that the technique will operate with a wide array of desired mobile devices (e.g., all popular types of cellular phones), a pilot format is preferably defined as an underlying aspect of the technique. The pilot format is preferably identified in front of the start point of the content corresponding to the encoded QR code. The pilot format preferably discloses (1) the original QR code's width, i.e., how many sub-areas per line; (2) a unique image to represent the start of a new QR code; (3) a cellular phone's character size, e.g., 16*16 or 20*20 or 24*24; (4) the size of the representation character.

d) Coding algorithm. By way of example, a number “N” of characters are used to represent any given sub-area. For example, if the image content is divided into a given sub-area of 16*16, there are 256 locations in the sub-area, and thus there are 2̂256 possibilities to represent the sub-area of that size. (FIG. 10, step 1002). This may be too large of a character database to manage in a given platform, so further division may be employed to reduce the size of the library of characters, essentially compressing the character database. Thus, the image content may be further divided into smaller areas, which may also be referred to as sub-sub-areas. (FIG. 10, 1004). For example, division into 4*4 sub-areas produces a sub-area having 16 pixel locations, which can be represented by a character database of 2̂16, or 65,536 characters. By way of example, UNICODE may be used in connection with the encoding technique, as UNICODE represents 100K different characters, which is sufficient to handle the 65,536 characters in the latter example. In this fashion, each sub-area can be represented by a character in a corresponding character database. (FIG. 10, 1006)

e) Compression algorithm. To solve the problem of representation, the overall length of a message is increased. A compression algorithm may then also be used in order to decrease the length of message to a usable size, depending upon message format constraints. Essentially, this involves identifying neighboring sets of sub-areas (or sub-sub areas and determining whether the neighboring sets can collectively be represented by a character in the character database (FIG. 10, 1008). Then, the number of sub-areas (or sub-sub areas) can be iteratively enlarged until the point where there is no longer a match in the database. The largest set for which there is a match is adopted. (FIG. 10, 1010) In a specific example, the iterative process of identifying a matching character for the largest possible set of neighboring areas comprises:

(1) making the sub-sub-area image (e.g., 4*4) and its neighbor and neighbor's neighbor into one image;

(2) accessing a commonly used image database that has been defined according to the constraints of a supported encoding algorithm (e.g., the remainder of the 100K UNICODEs, or 100K−65,536=34464 additional remaining characters). Continuing with the example, the normal 4*4 sub-areas, i.e. the smallest sub-areas, will be represented by the noted 65,536 characters. Enlarged areas, referred to as sets of neighboring areas, may be collectively represented by a single character among the additional remaining characters.

(3) iteratively enlarge the area of the comprised image (e.g., from 4*4 to 4*8 to 8*8 to 8*16, to 16*16, etc.) until there is no match among the additional remaining characters in the database. Then, the final matched character is determined to be the representative for the comprised area.

Following the identification of the characters that respectively represent the image content, the characters may be composed into a standard message that can be sent to the mobile device. (FIG. 10, 1012).

It is reiterated that this algorithm can be used as an image compression algorithm for any image's representation, including video data, rather than just 2-dimensional codes. In a video embodiment, the still image is represented as described above, and sequential content in successive frames (or differences in time) adds a third dimension. The sub-image or neighboring set of sub-images at a first point in time (or frame) is compared to a second point in time (or frame). A character can be used to represent the sub-image or neighboring set of sub-images, repeatedly where no changes in the video image occur, with an update being made once a change has occurred in the sub-image or neighboring set of sub-images. In the example where video data is being represented, a time parameter representing the duration between frames would be introduced to the pilot format.

The code conversion server 110 encodes the code according to the above-described technique and then transmits it to the mobile device 120, such as through conventional SMS messaging communications. The mobile derive 120 may then re-transmit the message contents to the code generation apparatus 130, which then uses the reverse algorithm (in the decoding direction) to decode the encoded code, and thereby reproduce the code. The code is then transmitted to the code reading device 150 for completion of the transaction as described regarding FIG. 1.

With the code generation and reading functionality installed at the merchant location 160 for authentication and verification of customers' mobile message, customers are able to use mobile phones that don't support certain technologies to facilitate completion of online shopping transactions at offline merchant locations. For example, the consumer may complete a transaction requiring a QR code even where the consumer's mobile device 120 does not include MMS (multimedia messaging services) facilities to carry out receiving and conveying the QR code to the merchant.

As an alternative, the program code for decoding the encoded image content may be provided within the mobile device 120. Thus, the mobile device 120 may receive a simple message containing the string of characters, as described, but may employ the character database and corresponding program code stored locally so that the mobile device 120 itself can be used to decode and display the corresponding image content (e.g., the QR code) in decoded form, notwithstanding the inability of the mobile device 120 to receive the image content (e.g., QR code) directly through an MMS based communication or the like. In this fashion, the mobile device 120 may itself be used to display the image content (e.g., QR code) in order to complete a transaction at the merchant location 160.

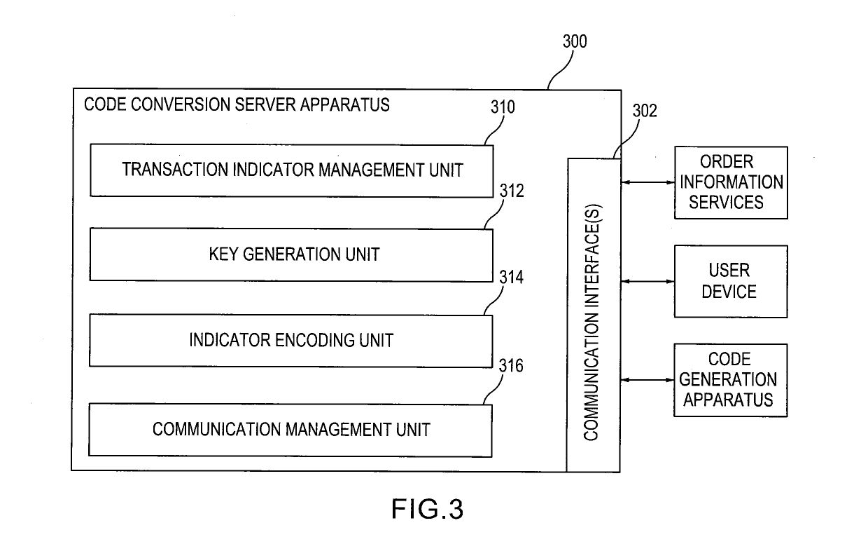

FIG. 3 is a block diagram illustrating an example of a code conversion server 300 apparatus configured to facilitate transactions by devices that do not support transaction identifier type(s).

The code conversion server 300 may be designed to perform the code conversion example described in FIG. 1, or that described in FIG. 2, or can be designed to perform both types of code conversion. Although one modular breakdown of the code conversion server 300 is described, it should be understood that the same functionality may be performed by fewer, greater, or differently named modules. Additionally, the code conversion server 300 includes corresponding processing unit(s), and memory for storing program code executable by the processing unit(s) to perform the operations described herein. In one embodiment, the code conversion server 300 is a special purpose machine, including the processor and memory, executing the specific code conversion algorithm described herein. In another embodiment, program code executable to perform the code conversion functionality is stored on a computer readable medium. In still another embodiment, it is an apparatus including the described units. Similar types of embodiments are also provided for the mobile device 400 and code generation apparatus 500, which also respectively include processor(s) and memory storing program code executable to provide the described functionality.

The code conversion server 300 includes communication interfaces 302 to accommodate the described communications to and from the order information services, user devices, and code generation apparatus.

Any communication channel may be used to carry out the described transmission of codes, keys and other information. Additionally, as noted, the code conversion server 300 may be equipped to handle either the examples of FIG. 1 or FIG. 2 above, but one uniquely configured to only implement the example of FIG. 2 would be able to omit the communications link between the code conversion server 300 and the code generation apparatus. These and other obvious omissions may be accommodated depending upon the particular implementation, and illustration in the figure should not be construed as an indication that all illustrated elements are required.

The code conversion server 300 may use public or private network communications to receive the code from the order information services. It should also be noted that a particular order information service provider may itself provide the code conversion functionality, in which case the order information service and the code conversion server 300 would be merged.

Additionally, the communications between the code conversion server 300 and the mobile device may implement wireless cellular network communications, particularly those supporting the transmission of data, or at least text messages, to the mobile device. Although this is envisioned as a preferred communication, other wireless communication channels, whether wireless LAN or short range wireless communications (e.g., Bluetooth) may be used. Still further, where the mobile device is initially connected in the home, there may be embodiments where the communications are over traditional networks (wired, wireless or both) while the device is in the home, etc. The present invention is not limited as to the type of communication channel.

Communications between the code conversion server 300 and the code generation apparatus may be similar to those provided between the code conversion server 300 and the order information services provider. Other communications channels including but not limited to cellular communications and wireless LAN may also be used.

The code conversion server 300 also includes a communication management unit 316 and a transaction indicator management unit 310. The communication management unit 316 manages communications with the order information services, mobile device, and code generation apparatus. The transaction indicator management unit 310 receives codes from the order information services, stores them, and associates them with consumers to further the provision of the codes to the code generation apparatus depending upon the implemented protocol. The key generation unit 312 is configured to provide functionality corresponding to the first example above, namely the generation of the key, association of the key and unique code with the consumer/mobile device, etc. The indicator encoding unit 314 is configured to provide functionality corresponding to the second example above, namely carrying out the encoding algorithm on the code (e.g., QR code) so that an encoded version may be sent to the mobile device. The communication management unit 316 is in operative communication with the remaining units and accesses the key and/or code and/or encoded code in order to send and receive information as described previously.

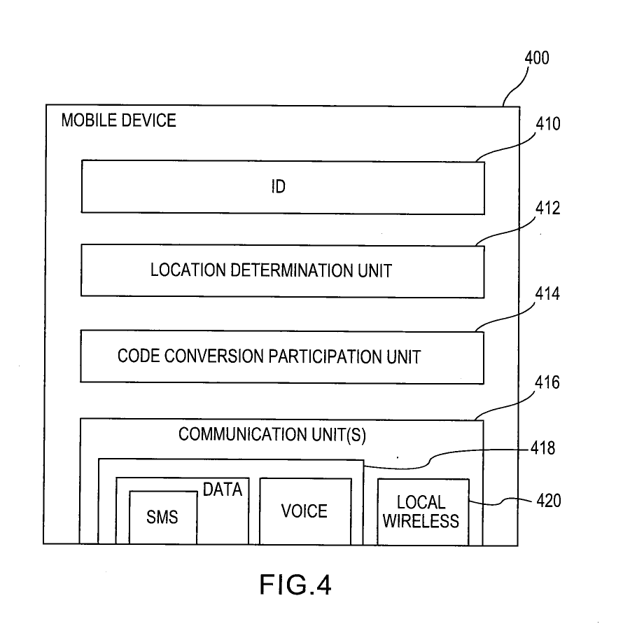

FIG. 4 is a block diagram illustrating an example of a mobile device 400 configured to operate in conjunction with the code conversion server. By way of example, the mobile device 400 may be configured as a cellular phone, smart phone, or the like. It may also be configured as a personal digital assistant, a pad-type computer, or any mobile computing device, typically of the type that is transported about by consumers. The mobile device 400 includes the basic conventional components of, for example, a cellular phone, which need not be described herein, such as an execution platform, audio/display components, etc.

The mobile device 400 also includes an ID module 410, location determination unit 412, code conversion participation unit 414, and communications unit(s) 416 such as typical cellular network communication 418 (e.g., 3G/4G/etc.) which supports traditional voice, data, and/or basic SMS type communications.

The mobile device 400 may also include facilities for additional local wireless communications 420, such as Bluetooth. Still further, the mobile device 400 may be configured for additional NFC two way communications, although more typically the ID module 410 will be an NFC tag that is used as the mobile device ID.

The location determination unit 412 is used to determine and provide, where necessary, the location of the mobile device 400. A GPS functionality is preferred, but other forms may also be provided, including location determination using the cellular network, or local proximity sensing.

The code conversion participation unit 414 is configured to provide the functionality described in the examples above, namely requesting, receiving and transmitting keys, encoded codes, any necessary order information, as well as related information pursuant to the placement of orders with order information services as well as the completion of orders at merchant locations as described.

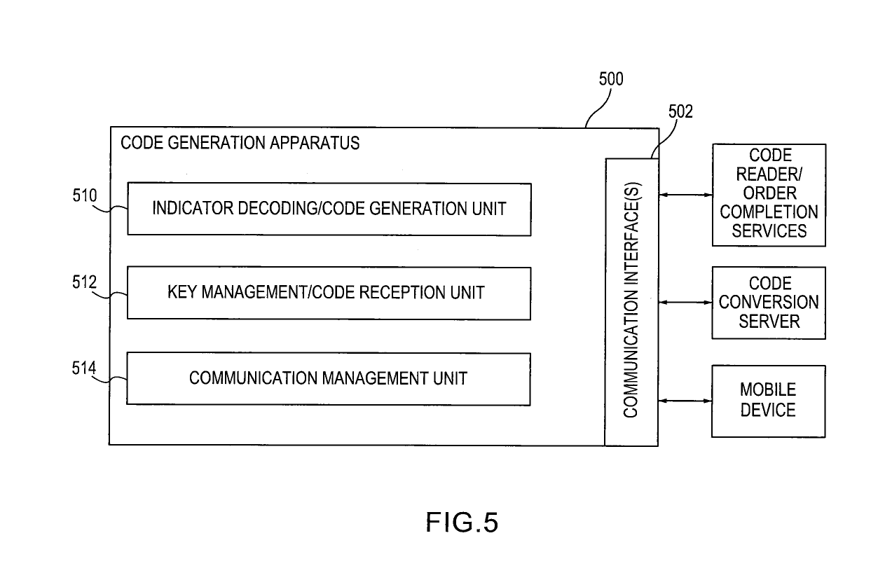

FIG. 5 is a block diagram illustrating an example of a code generation apparatus 500 configured to facilitate transactions by devices that do not support transaction identifier types.

The code generation apparatus 500 includes communication interfaces 502 including those to communicate with the mobile device and the code conversion server as previously described. It also interfaces with the code reading device, which may merely mean displaying, printing or otherwise transferring the code to the code reading device for further processing as has been described.

The code generation apparatus 500 also includes an indicator decoding/code generation unit 510, a key management/code reception unit 512 and a communication management unit 514. Basically, these units cooperate to provide the functionality described in connection with the first and/or second examples described in further detail above. The indicator decoding/code generation unit 510 is configured to receive encoded (e.g. QR) codes and to decode them to reproduce the codes according to the technique described above. The key management/code reception unit 512 is configured to receive keys, send them to the code conversion server, and receive them for presentation to the code reading device. The communication management unit 514 is configured to organize the communications with the other devices and to retrieve, receive and transmit corresponding key, code and other information accordingly.

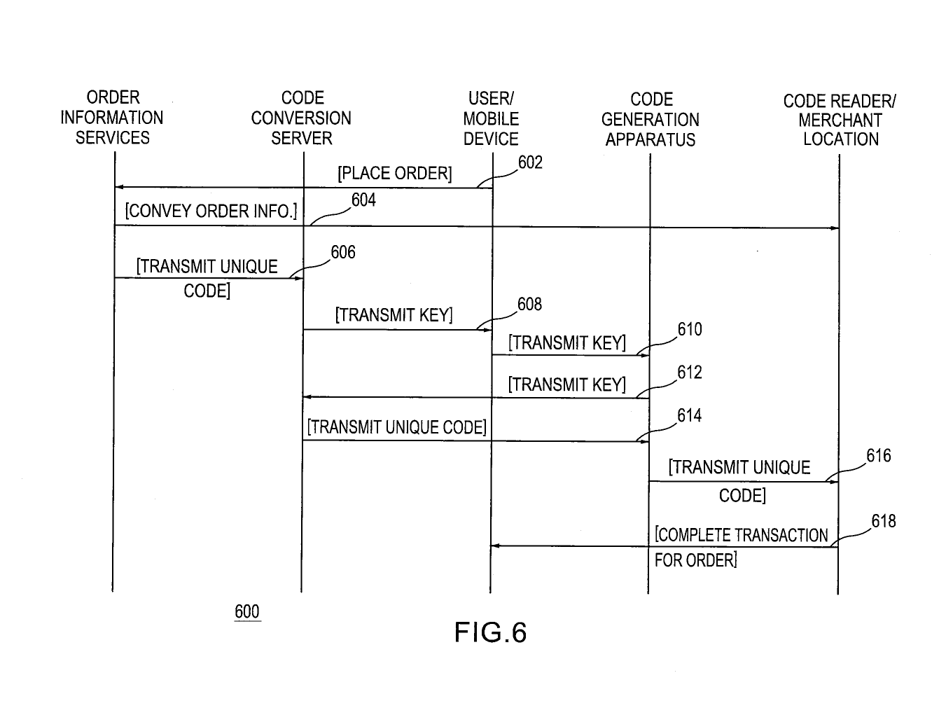

FIGS. 6-9 describe various methods for facilitating transactions. Although one sequential set of operations for FIGS. 6-9 is illustrated and described, this is for ease of discussion. It should be appreciated that the described operations do not need to occur in the illustrated and described sequence.

FIG. 6 is an event diagram illustrating an example of a method 600 for facilitating transactions using unsupported transaction identifier types. The method entails placing 602 an order by the user/consumer with one of the order information service providers. This may be an online shopping site, a media platform, a services platform, or any online facility for placing an order. Additionally, access may be through the Internet, a cellular network, or even through traditional voice contact with a customer service representative. Payment for the order may occur upon placement, or at a later time (such as when the order is completed, infra). The user/consumer may place 602 the order using his mobile device, or may alternatively use different channels such as home computer access, with later use of the mobile device to complete the transaction. In the latter example, the home computer may communicate information to the mobile device that can later be used to complete the transaction.

The order information services provider sends 604 order information to the merchant location, which is a location where the consumer will complete the order, such as by picking up the physical merchandise where goods are purchased.

The order information is associated with a unique code, such as a QR code, that can be used to identify the order when the consumer seeks to complete the order at the merchant location. In this example, the mobile device that the user implements in connection with attempting to complete the order does not support the display of the QR code. Although a QR code is mentioned, the present invention is not so-limited, and any unsupported transaction indicator type may be implemented.

The unique code is sent 606 to the code conversion server, such as through conventional network communications. As noted, the code conversion server may be an additional service provided by the order information services provider as well.

The code conversion server then generates a key associated with the order information, and transmits 608 the key to the consumer's mobile device. This will typically be done by conventional mobile device wireless communication, such as cellular, and in one embodiment is sent as a text message.

The consumer uses his mobile device, now storing the key, then transmits 610 the key to the code generation apparatus. Various forms of communicating the key may be used, as has been described, including a cellular based communication, or a local wireless connection, and NFC mobile device ID recognition may be implemented as well.

The code generation apparatus then transmits 612 the key to the code conversion server, which associates the key with the unique code, and transmits 614 the unique code back to the code generation apparatus. In turn, the code generation apparatus then transmits 616 the unique code to the code reader present at the merchant location. The unique code is associated with the order information, and the transaction for the order is completed 618 accordingly.

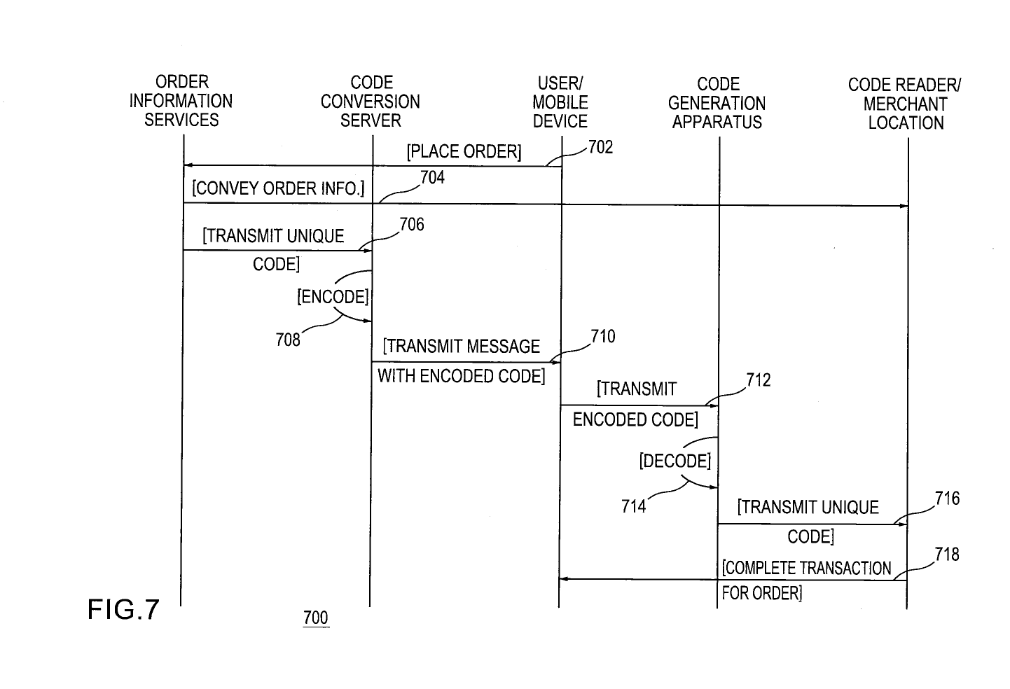

FIG. 7 is an event diagram illustrating another example of a method 700 for facilitating transactions using unsupported transaction identifier types. In this method 700, placing 702 the order, conveying 704 the order information, and transmitting 706 the unique code are as described in the previous example.

The code conversion server then encodes 708 the unique code so that it can be sent to the mobile device, via information supported by the mobile device. For example, the code may be a QR code, with the encoding algorithm used to generate an encoded code that can be transmitted 710 to the mobile device as a string of characters in one or more text messages. The algorithm has previously been described in detail.

The mobile device is then used to transmit 712 the encoded version of the code to the code generation apparatus. The code generation apparatus is equipped to reverse the encoding procedure carried out by the code conversion server, according to the same (reverse) algorithm, and as such decodes 714 the encoded code to reproduce the unique code.

Once this is accomplished, the code generation apparatus transmits 716 the unique code to the code reader at the merchant location, to facilitate completion 718 of the transaction corresponding to the order that had been originally placed by the consumer.

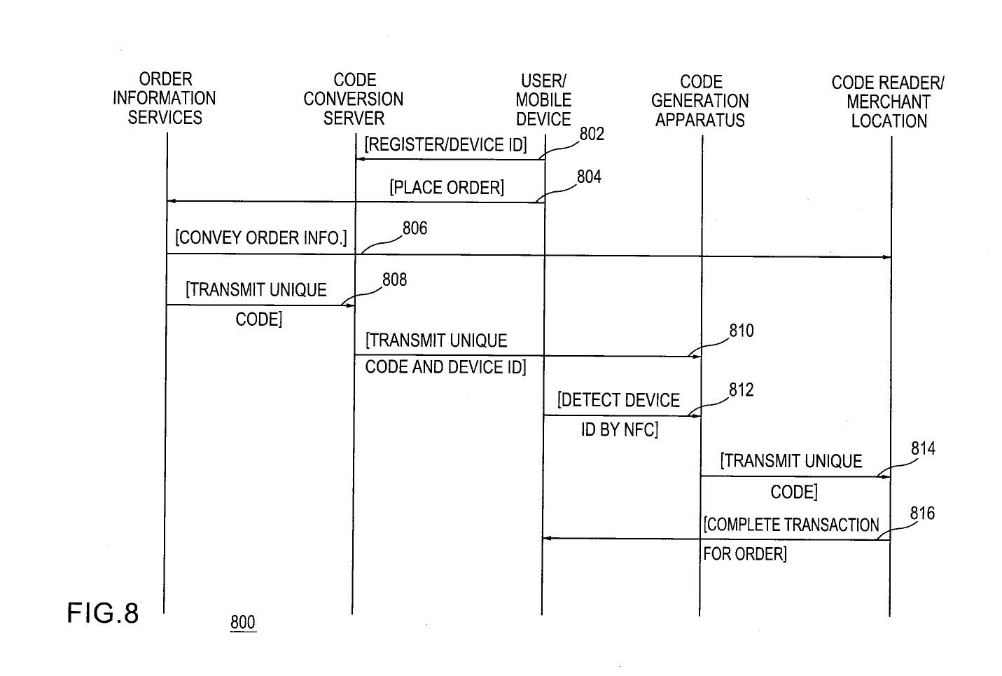

FIG. 8 is an event diagram illustrating an example of a method 800 of completing a transaction using a unique code (e.g., QR code), upon proximity detection of the mobile device (e.g., by NFC). In this example, the consumer may initially register 802 the mobile device with the code conversion server. In this fashion, an identifier for the mobile device may be used for later identification thereof. In one example, the identifier is the NFC tag of the mobile device.

The consumer places 804 an order with the online order information services provider, which transmits 806 the order information to the merchant location, and transmits 808 the unique code to the code conversion server, as previously described.

The code conversion server then transmits 810 the unique code and the mobile device ID to the code generation apparatus. The two are associated so that when the consumer uses the merchant device at the appropriate location, the mobile device ID can prompt retrieval of the appropriate unique code.

The code generation apparatus and the code reader are present, and indeed may be part of the same POS terminal, at the merchant location. The consumer may bring the mobile device into the merchant location, and bring it into sufficient proximity to a designated location at the merchant location (e.g., a spot at the POS terminal) whereupon NFC is used to automatically and immediately detect 812 and identify the mobile device through receipt of the NFC tag.

As an alternative to directly using the NFG tag as the mobile device ID, the NFC tag may be used for initial identification and automatic generation of another communication channel to transmit information. This other communication channel may be, for example, a Bluetooth communication channel.

Regardless, having the unique code associated with the NFC tag (acting as the mobile device ID) the code generation apparatus retrieves from memory, and then transmits 814 the unique code to the code reader, whereupon the transaction for the order is completed 816.

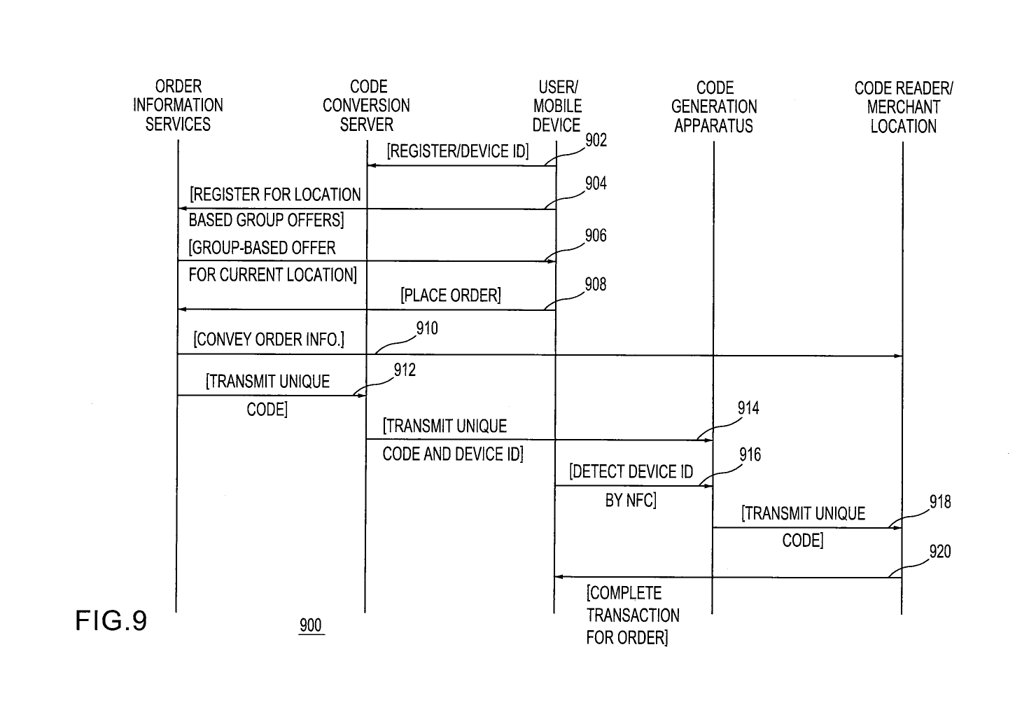

FIG. 9 is an event diagram illustrating an example of another method 900 for completing a transaction using information such as a unique code (e.g., QR code) in conjunction with a group based offer associated with the location of a corresponding mobile device (e.g., by GPS).

The method 900 may entail initial registration 902 of the mobile device with the code conversion server, such as where the NFC tag acts as the ID of the mobile device.

Here, however, there may be an additional registration of the mobile device (or consumer generally) for location-based group offers. By such registration, the consumer seeks to receive group benefit offers (e.g., coupon, special price, or other accommodation provided for a group) for particular items or services. The group offers may also depend upon the location of the consumer (said location being determinable through the location of the consumer's mobile device). Although this registration is shown being made with the online order information services providers, it may alternatively be made with another entity specializing in group benefit offers, with that entity in turn having relationships with the online order information services providers to convey group benefit offers.

Having registered 902, 904 accordingly, the consumer may then receive 906 a group benefit offer, and then engage in the placement 908 of an order for the designated item/service/etc. The group benefit offer may be made based upon a determination that the consumer is present at a given location. The location is preferably determined from the mobile device GPS or other location determining technology for the mobile device. The given location may be variously defined, such as within a predetermined radius of a point location, or within a designated town or boundary, or with a given merchant location or location with numerous merchants (e.g., shopping mall).

Following this, the order information services provider conveys 910 the order information to the merchant location so that the order may be completed by the consumer. As noted, the code reader and the code generation apparatus may be part of the same basic merchant location apparatus, such as a POS terminal.

The order information services provider transmits 912 information such as the unique code (e.g., QR code) to the code conversion server, and the code conversion server transmits 914 the information and the mobile device ID to the code generation apparatus. As in the previous example, NFC may be used to automatically detect 916 and identify the mobile device once it is brought into NFC-defined proximity of a designated location at the merchant location. This prompts the code generation apparatus to retrieve and transmit 918 the unique code to the code reader, to facilitate completion 920 of the order. Consistent with the alternatives described above, the information sent to the code generation apparatus may extend beyond the unique code, or the unique code itself. It may be encrypted information about the order that is partially or wholly decrypted by a key, which may be provided to the code generation apparatus upon proximity detection as described. These and other alternatives described above may be employed in this embodiment.

In this fashion, the consumer, having registered with the code conversion server and the group benefit services provider, can be immediately made aware of group based offers when he has his mobile phone in a given location (e.g., shopping mall), make corresponding orders for items, and then use his cell phone to immediately engage in the completion of the transaction for the order through automatic identification thereof.

Thus embodiments of the present invention produce and provide systems, methods, apparatus and articles of manufacture for facilitating transactions using unsupported transaction identifiers. Although the present invention has been described in considerable detail with reference to certain embodiments thereof, the invention may be variously embodied without departing from the spirit or scope of the invention. Therefore, the following claims should not be limited to the description of the embodiments contained herein in any way.

1. A method for facilitating transactions, the method comprising:
receiving a unique transaction indicator having a transaction indicator type, and an indication that a corresponding transaction is to be carried out with a device that does not adequately support the transaction indicator type; and
sending information to the device to allow the corresponding transaction to be completed.

2. The method of claim 1, wherein sending information to the device comprises sending an identifier corresponding to the unique transaction indicator to the device, and further comprising:
sending the identifier and the unique transaction indicator to a transaction facilitation apparatus at a location wherein the corresponding transaction is to be completed.

3. The method of claim 2, wherein the transaction indicator type is a two dimensional code.

4. The method of claim 2, wherein the device is a mobile terminal device.

5. The method of claim 2, wherein sending the identifier and the unique transaction identifier to the transaction facilitation apparatus allows the transaction facilitation apparatus to receive the identifier from the device, to associate the device to the unique transaction indicator in connection with a completion of the corresponding transaction.

6. The method of claim 5, wherein the completion of the corresponding transaction is provision of goods or services to a user of the device, said goods or services having been previously ordered at another location.

7. The method of claim 1, wherein sending information to the device comprises sending an encoded version of the unique transaction indicator to the device, the encoded version of the unique transaction indicator comprising characters, the characters being configured for conversion to the unique transaction indicator at a location wherein the corresponding transaction is to be completed.

8. The method of claim 7, wherein the transaction indicator type is a two dimensional code.

9. The method of claim 7, wherein the device is a mobile terminal device.

10. The method of claim 7, wherein sending the encoded version of the unique transaction indicator to the device allows the device to send the encoded version to a transaction facilitation apparatus, to accommodate association of the device to the unique transaction indicator in connection with a completion of the corresponding transaction.

11. The method of claim 10, wherein the completion of the corresponding transaction is provision of goods or services to a user of the device, said goods or services having been previously ordered at another location.

12. The method of claim 7, wherein the encoded version is sent to the device using text messaging, and the characters comprising a string of numeric, alphabetic, or alphanumeric characters decodable by the transaction facilitation apparatus to reproduce the unique transaction indicator.

13. The method of claim 7, wherein the encoded version of the unique transaction indicator is prepared according to a process comprising:
dividing an image constituting the unique transaction indicator into a plurality of sub-areas; and
representing each of the sub-areas using the characters, which respectively represent the content of each sub-area.

14. The method of claim 13, further comprising compressing the representation of the image by identifying neighboring sets of the sub-areas, accessing a character database to determine whether the character database includes a current matching character to uniquely represent the neighboring sets of the sub-areas.

15. The method of claim 14, further comprising increasing the number of sub-areas in the neighboring sets of the sub-areas, until it is determined that the character database no longer has a new matching character to uniquely represent the neighboring sets of the sub-areas, and adopting the current matching character when it is determined that the new matching character is not present in the character database.

16. A computer program product comprising a computer readable medium having program code stored thereon, the program code being executable by a processor to perform operations comprising:
receiving a unique transaction indicator having a transaction indicator type, and an indication that a corresponding transaction is to be carried out with a device that does not adequately support the transaction indicator type; and
sending information to the device to allow the corresponding transaction to be completed.

17. An apparatus for facilitating transactions, the apparatus comprising:
means for receiving a unique transaction indicator having a transaction indicator type, and an indication that a corresponding transaction is to be carried out with a device that does not adequately support the transaction indicator type; and
means for sending information to the device to allow the corresponding transaction to be completed.

18. A method for compressing image content, the method comprising:
dividing the image content into a plurality of sub-areas; and
representing each of the sub-areas using characters in a character database, which respectively represent the content of each sub-area.

19. The method of claim 18, further comprising compressing the representation of the image content by identifying neighboring sets of the sub-areas, and accessing the character database to determine whether the character database includes a current matching character to uniquely represent the neighboring sets of the sub-areas.

20. The method of claim 19, further comprising increasing the number of sub-areas in the neighboring sets of the sub-areas, until it is determined that the character database no longer has a new matching character to uniquely represent the neighboring sets of the sub-areas, and adopting the current matching character when it is determined that the new matching character is not present in the character database.

21. The method of claim 18, wherein the image content is a video signal.

22. A method for facilitating transactions, the method comprising:
receiving encrypted order information, the order information being for a corresponding transaction is to be carried out with a mobile device;
receiving a key from the mobile device; and
decrypting the order information to allow the corresponding transaction to be completed.

23. The method of claim 22, wherein the corresponding transaction is a group based offer associated with the location of the mobile device.

24. The method of claim 22, wherein receiving the key from the mobile device is immediately performed in association with a detection of the mobile device via near field communication.
